(19) United States
(12) Patent Application Publication
(10) Pub. No.: US 2026/0301413 A1
(43) Pub. Date: Oct. 1, 2026

(54) METHOD AND SYSTEM FOR ESTIMATING PEDESTRIAN VULNERABILITY USING DEPTH INFORMATION

(71) Applicant: ELECTRONICS AND TELECOMMUNICATIONS RESEARCH INSTITUTE, Daejeon (KR)

(72) Inventors: Daehoe Kim, Daejeon (KR); Jin Young Moon, Daejeon (KR); Yongjin Kwon, Daejeon (KR); JONGHEE KIM, Daejeon (KR); Sungchan Oh, Daejeon (KR); Je-Seok Ham, Daejeon (KR)

(21) Appl. No.: 19/556,749

(22) Filed: Mar. 4, 2026

(30) Foreign Application Priority Data
Mar. 31, 2025 (KR) 10-2025-0041394

(51) Int. Cl. G06V 20/54; G06T 7/11; G06T 7/194; G06T 7/593; G06V 10/26; G06V 10/77; G06V 10/82; G06V 20/70

(52) U.S. Cl. CPC G06V 20/54; G06T 7/11; G06T 7/194; G06T 7/593; G06V 10/273; G06V 10/7715; G06V 10/82; G06V 20/70; G06T 2207/10024; G06T 2207/20081; G06T 2207/20084; G06T 2207/20132; G06T 2207/30196; G06T 2207/30232; G06T 2207/30236

(57) ABSTRACT

Provided are a method and system for estimating pedestrian vulnerability using depth information. The pedestrian situation estimation method according to the present invention includes generating pedestrian area information, which is information on an area occupied by a pedestrian appearing in an image of a target zone; generating a segmentation map of the image of the target zone and extracting ground region information from the segmentation map; generating depth information of an object area appearing in the image of the target zone; and estimating a situation of the pedestrian using a pedestrian situation estimation network based on an artificial neural network, based on the image of the target zone, the pedestrian area information, the segmentation map, the ground region information, and the depth information.

### CROSS-REFERENCE TO RELATED APPLICATION

This application claims priority to and the benefit of Korean Patent Application No. 10-2025-0041394, filed on Mar. 31, 2025, the disclosure of which is incorporated herein by reference in its entirety.

### BACKGROUND

### 1. Field of the Invention

The present invention relates to video processing technology and artificial intelligence technology.

This work was supported by Institute of Information & Communications Technology Planning & Evaluation (IITP) grant funded by the Korean government (MSIT) (RS-2020-II200004, Development of Provisional Intelligence based on Long-term Visual Memory Network)

### 2. Description of Related Art

Technology for recognizing a pedestrian at a potentially risk location, such as a road or crosswalk, based on a video from a surveillance camera (for example, a CCTV or an IP camera) is necessary for the safety of the pedestrian. For example, using this technology, information indicating the presence of a pedestrian may be transferred to drivers of vehicles when there is a pedestrian on a road or crosswalk while the vehicles are traveling. However, research on such technology is still in its infancy, and the performance of the technology needs to be improved for effective application to actual environments.

In the related art, a method of setting a region of interest such as a crosswalk in a video in advance and determining whether a detected or tracked person is in the region of interest is mainly used. However, the related art has the limitation that a user needs to individually set a region of interest for each surveillance camera. To address this limitation, technology for generating and utilizing a ground area map through semantic segmentation has been proposed. However, the technology utilizing semantic segmentation suffers from a problem of degraded risk situation estimation performance because it is difficult to distinguish between a pedestrian and an area actually adjacent to the pedestrian using only a two-dimensional image when a road or crosswalk area is occluded by traffic lights, road signs, or the like.

### SUMMARY OF THE INVENTION

The present invention is directed to providing a method and system for estimating pedestrian vulnerability in an image by using depth information extracted from an RGB image acquired through a surveillance camera, and an artificial intelligence model.

Specifically, the present invention is directed to providing a method and system for estimating pedestrian vulnerability in consideration of information on an area actually adjacent to the pedestrian by utilizing the depth information acquired from the image when it is estimated whether a pedestrian is at a potentially risk location such as on a road or a crosswalk, based on a video of a surveillance camera frequently occluded by a traffic light or road sign.

The present invention is not limited to the above-described objects, and other objects that are not mentioned will be clearly understood by those skilled in the art from the following description.

A pedestrian situation estimation system according to an aspect of the present invention includes a memory configured to store computer-readable instructions, and at least one processor implemented to execute the instructions.

The at least one processor is configured to execute the instructions to generate pedestrian area information, which is information on an area occupied by a pedestrian appearing in an image of a target zone, based on the image of the target zone, apply a semantic segmentation technique to the image of the target zone to generate a segmentation map and extract ground region (for example: road area, sidewalk, shoulder, parking lot, crosswalk) information, which is information in which a ground region is distinguished, from the segmentation map, generate depth information of an object area appearing in the image of the target zone based on the image of the target zone, and estimate a situation of the pedestrian using a pedestrian situation estimation network based on an artificial neural network, based on the image of the target zone, the pedestrian area information, the segmentation map, the ground region information, and the depth information.

The at least one processor may be configured to, in a process of estimating the situation of the pedestrian, calculate an average depth of the pedestrian based on the segmentation map, the pedestrian area information, and the depth information, and extract a ground region having a depth difference within a predetermined threshold from the average depth of the pedestrian from the ground region information to generate refined ground region information, and extract an image of an area around the pedestrian from the image of the target zone using the pedestrian area information, encode the image of the area around the pedestrian and the refined ground region information, and input these to the pedestrian situation estimation network to calculate a risk situation probability of the pedestrian.

The at least one processor may be configured to, in a process of generating the refined ground region information, crop an area corresponding to a predetermined multiple of an area occupied by the pedestrian from the ground region information and the depth information based on the pedestrian area information, generate a pedestrian area mask, which is a mask for the area occupied by the pedestrian, using the segmentation map and apply the pedestrian area mask to the cropped depth information to calculate the average depth of the pedestrian, and extract a ground region having a depth difference within a predetermined threshold from the average depth of the pedestrian from the cropped ground region information to generate the refined ground region information.

The at least one processor may be configured to, in a process of calculating the risk situation probability of the pedestrian, crop an area corresponding to a predetermined multiple of an area occupied by the pedestrian from the image of the target zone based on the pedestrian area information to generate the image of the area around the pedestrian, mask the area occupied by the pedestrian in the image of the area around the pedestrian, input the masked image of the area around the pedestrian to a pre-trained image encoder to generate a first feature map, input the refined ground region information to a map encoder to generate a second feature map, and input the first feature map and the second feature map to the pedestrian situation estimation network to calculate the risk situation probability of the pedestrian.

A pedestrian situation estimation method according to an aspect of the present invention includes generating, by a pedestrian situation estimation system, pedestrian area information, which is information on an area occupied by a pedestrian appearing in an image of a target zone, based on the image of the target zone, applying, by the pedestrian situation estimation system, a semantic segmentation technique to the image of the target zone to generate a segmentation map and extracting ground region information, which is information in which a ground region is distinguished, from the segmentation map, generating, by the pedestrian situation estimation system, depth information of an object area appearing in the image of the target zone based on the image of the target zone, and estimating, by the pedestrian situation estimation system, a situation of the pedestrian using a pedestrian situation estimation network based on an artificial neural network, based on the image of the target zone, the pedestrian area information, the segmentation map, the ground region information, and the depth information.

In an aspect of the present invention, the generating of the depth information includes generating, by the pedestrian situation estimation system, the depth information by estimating a relative distance between each of pixels representing a plurality of objects appearing in the image of the target zone and a camera installed in the target zone, based on the image of the target zone.

In an aspect of the present invention, the depth information is either a depth map or a disparity map.

In an aspect of the present invention, the estimating of the pedestrian situation includes calculating, by the pedestrian situation estimation system, an average depth of the pedestrian based on the segmentation map, the pedestrian area information, and the depth information, and extracting a ground region having a depth difference within a predetermined threshold from the average depth of the pedestrian from the ground region information to generate refined ground region information, and extracting, by the pedestrian situation estimation system, an image of an area around the pedestrian from the image of the target zone using the pedestrian area information, encoding the image of the area around the pedestrian and the refined ground region information, and inputting these to the pedestrian situation estimation network to calculate a risk situation probability of the pedestrian.

In an aspect of the present invention, the generating of the refined ground region information includes cropping an area corresponding to a predetermined multiple of the area occupied by the pedestrian from the ground region information and the depth information based on the pedestrian area information, generating a pedestrian area mask, which is a mask for the area occupied by the pedestrian, using the segmentation map, and applying the pedestrian area mask to the cropped depth information to calculate the average depth of the pedestrian, and extracting a ground region having a depth difference within a predetermined threshold from the average depth of the pedestrian from the cropped ground region information to generate the refined ground region information.

In an aspect of the present invention, the calculating of the risk situation probability of the pedestrian includes cropping an area corresponding to a predetermined multiple of an area occupied by the pedestrian from the image of the target zone based on the pedestrian area information to generate the image of the area around the pedestrian, masking the area occupied by the pedestrian in the image of the area around the pedestrian, inputting the masked image of the area around the pedestrian to a pre-trained image encoder to generate a first feature map, inputting the refined ground region information to a map encoder to generate a second feature map, and inputting the first feature map and the second feature map to the pedestrian situation estimation network to calculate the risk situation probability of the pedestrian.

In an aspect of the present invention, the image encoder is VGG19 trained on ImageNet in advance.

In an aspect of the present invention, the map encoder performs an atrous convolution operation.

In an aspect of the present invention, the pedestrian situation estimation network includes a concatenation unit configured to concatenate the first feature map and the second feature map in a channel direction, a two-dimensional convolution unit configured to input the first feature map and the second feature map concatenated in the channel direction to a convolution layer to generate a fused feature, a flattening unit configured to flatten the fused feature, a first fully connected layer configured to input the flattened feature to a fully connected layer to generate a feature vector, an attention unit configured to input the feature vector to a multi-head self-attention layer to generate a pedestrian situation feature, and a second fully connected layer configured to input the pedestrian situation feature to a fully connected layer to calculate the risk situation probability of the pedestrian.

In an aspect of the present invention, the estimating of the situation of the pedestrian includes estimating the situation of the pedestrian as either a risk situation or a safe situation based on the risk situation probability of the pedestrian calculated by the pedestrian situation estimation network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a pedestrian situation estimation system according to an embodiment of the present invention;

FIG. 2 is a flowchart illustrating a pedestrian situation estimation method according to an embodiment of the present invention;

FIG. 3 is a diagram illustrating a process of refining a ground region map using depth information;

FIGS. 4A to 4F are diagrams illustrating data related to a process of refining a ground region map using a depth map;

FIG. 5 is a diagram illustrating a process of estimating a situation of the pedestrian;

FIG. 6 is a diagram illustrating a structure of an artificial neural network that estimates a situation of the pedestrian;

FIGS. 7A and 7B are diagrams illustrating a comparison of pedestrian situation estimation results between the related art and the present invention; and

FIGS. 8A and 8B are diagrams illustrating a comparison of pedestrian situation estimation results between the related art and the present invention.

### DETAILED DESCRIPTION OF EXEMPLARY EMBODIMENTS

The present invention relates to a method and system for estimating a pedestrian vulnerability appearing in an image acquired from a camera installed in a zone through which the pedestrian passes, using depth information extracted from the image and artificial intelligence.

The advantages and features of the present invention and a method of achieving the advantages and features will become clearer with reference to the embodiments to be described below in detail with the accompanying drawings. However, the present invention is not limited to the embodiments to be disclosed below, but may be implemented in various different forms, and the embodiments are provided solely to complete the disclosure of the present invention and to fully inform those skilled in the art of the scope of the invention, and the present invention is defined solely by the claims. Meanwhile, the terms used herein are for the purpose of describing embodiments and are not intended to limit the present invention. In the present specification, singular forms also include plural forms unless specifically stated otherwise. The terms “comprise” and/or “comprising” as used herein do not exclude the presence or addition of one or more other components, steps, operations, and/or elements.

Terms such as “first” and “second” may be used to describe various components, but the components should not be limited by the terms. The terms may be used to distinguish one component from another. For example, a first component may be referred to as a second component, and similarly, a second component may also be referred to as a first component, without departing from the scope of the present invention.

When a component is referred to as being “connected” or “coupled” to another component, it should be understood that the component may be directly connected or coupled to the other component, but other intervening components may also be present in between. On the other hand, when a component is referred to as being “directly connected” or “directly coupled” to another component, it should be understood that there are no other intervening components. Other expressions that describe a relationship between components, such as “between” and “directly between” or “adjacent to” and “directly adjacent to” should also be construed similarly.

In describing the present invention, detailed description of related known technologies will be omitted when the description is deemed to unnecessarily obscure the gist of the present invention.

Hereinafter, embodiments of the present invention will be described in detail with reference to the accompanying drawings. To facilitate a comprehensive understanding of the present invention, the same means will be denoted by the same reference numerals throughout the drawings.

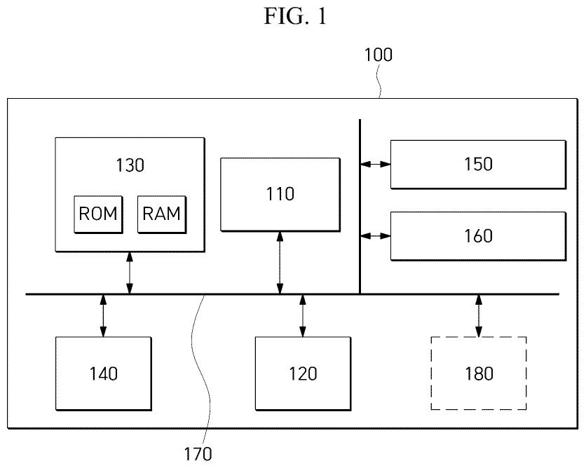

FIG. 1 is a block diagram illustrating a configuration of a pedestrian situation estimation system according to an embodiment of the present invention. The pedestrian situation estimation system 100 according to the embodiment of the present invention may be implemented in the form of a computing device (computer system) illustrated in FIG. 1.

The pedestrian situation estimation system 100 extracts pedestrian location (area) information (for example, pedestrian coordinates and a bounding box), ground region information (for example, a ground region map), and depth information (for example, a depth map and a disparity map) from a video captured by a camera 180 installed in a target zone, and estimates the situation of the pedestrian by fusing and analyzing pedestrian location (area) information (which may be referred to as pedestrian area information in the case of a bounding box), ground region information, and depth information. Here, the situation of the pedestrian may be either pedestrian vulnerability (risk situation) or a safety situation.

Referring to FIG. 1, the pedestrian situation estimation system 100 may include at least one processor 110, a memory 130, an input interface device 150, an output interface device 160, and a storage device 140 that perform communication via a bus 170.

Further, the pedestrian situation estimation system 100 may further include a communication device 120 coupled to a network. In this case, the pedestrian situation estimation system 100 may receive an image captured by the camera 180 installed in a target zone via the communication device 120.

As another example, the pedestrian situation estimation system 100 may further include the camera 180.

The target zone of the present invention is an area through which pedestrians pass. For example, the target zone may be a crosswalk or a school safety zone. The camera 180 may be fixedly installed in the target zone.

The pedestrian situation estimation system 100 illustrated in FIG. 1 is an embodiment, and components of the pedestrian situation estimation system 100 according to the present invention are not limited to those in the embodiment illustrated in FIG. 1 and may be added, modified, or deleted as needed.

The processor 110 may be a central processing unit (CPU) or a semiconductor device that executes computer-readable instructions stored in the memory 130 or storage device 140.

The memory 130 and the storage device 140 may include various types of volatile or nonvolatile storage media. For example, the memory 130 may include a read-only memory (ROM) and a random access memory (RAM).

In embodiments of the present disclosure, the memory 130 may be located inside or outside the processor 110, and may be connected to the processor 110 via various known means. The memory 130 may be any type of volatile or nonvolatile storage medium, and for example, the memory 130 may include a read-only memory (ROM) or a random access memory (RAM).

Therefore, embodiments of the present disclosure may be implemented as a computer-implemented method or may be implemented as a non-transitory computer-readable medium in which computer-executable instructions are stored. In an embodiment, when the computer-readable instructions are executed by the processor 110, a method according to at least one aspect of the present disclosure may be performed.

The communication device 120 may transmit or receive wired or wireless signals.

Further, a pedestrian situation estimation method according to an embodiment of the present invention may be implemented in the form of program instructions that can be executed through various computer means and recorded on a computer-readable medium.

The computer-readable medium may include program instructions, data files, data structures, or the like alone or in combination. The program instructions recorded on the computer-readable medium may be those specially designed and configured for the embodiment of the present invention or may be those known and available to those skilled in the art of computer software. The computer-readable recording medium may include a hardware device configured to store and execute the program instructions. Examples of the computer-readable recording medium include a magnetic medium such as a hard disk, a floppy disk, and a magnetic tape, an optical medium such as a CD-ROM and a DVD, a magneto-optical medium such as a floptical disk, a ROM, a RAM, and a flash memory. Examples of the program instructions include not only machine language codes such as those created by a compiler, but also high-level language codes that can be executed through an interpreter or the like by a computer.

The processor 110 is configured to execute computer-readable instructions stored in the memory 130 or the storage device 140, to generate pedestrian area information, which is information on an area occupied by a pedestrian appearing in the image of the target zone, based on an image of the target zone, apply a semantic segmentation technique to the image of the target zone to generate a segmentation map, extract ground region information, which is information in which a ground region (for example: road area, sidewalk, shoulder, parking lot, crosswalk) is divided, from the segmentation map, generate depth information of an object area appearing in the image of the target zone based on the image of the target zone, and estimate a situation of the pedestrian using a pedestrian situation estimation network based on an artificial neural network, based on the image of the target zone, the pedestrian area information, the segmentation map, the ground region information, and the depth information. In the present specification, the “depth information of the object area” is depth information of each pixel of an area occupied by an object in the image of the target zone.

In an embodiment of the present invention, the processor 110 is configured to generate the depth information by estimating a relative distance between each of pixels representing a plurality of objects appearing in the image of the target zone and a camera installed in the target zone, based on the image of the target zone in a process of generating the depth information.

The depth information may be any one of a depth map and a disparity map.

In an embodiment of the present invention, in a process of estimating the situation of the pedestrian, the processor 110 is configured to calculate an average depth of the pedestrian based on the segmentation map, the pedestrian area information, and the depth information, and extract a ground region having a depth difference within a predetermined threshold from the average depth of the pedestrian from the ground region information to generate refined ground region information, and extract an image of an area around the pedestrian from the image of the target zone using the pedestrian area information, encode the image of the area around the pedestrian and the refined ground region information, and input these to the pedestrian situation estimation network to calculate a risk situation probability of the pedestrian.

In an embodiment of the present invention, in a process of generating the refined ground region information, the processor 110 is configured to crop an area corresponding to a predetermined multiple of an area occupied by the pedestrian from the ground region information and the depth information based on the pedestrian area information, generate a pedestrian area mask, which is a mask for the area occupied by the pedestrian, using the segmentation map and apply the pedestrian area mask to the cropped depth information to calculate the average depth of the pedestrian, and extract a ground region having a depth difference within a predetermined threshold from the average depth of the pedestrian from the cropped ground region information to generate the refined ground region information.

In an embodiment of the present invention, in a process of calculating a risk situation probability of the pedestrian, the processor 110 is configured to crop an area corresponding to a predetermined multiple of an area occupied by the pedestrian from the image of the target zone based on the pedestrian area information to generate the image of the area around the pedestrian, mask the area occupied by the pedestrian in the image of the area around the pedestrian, input the masked image of the area around the pedestrian to a pre-trained image encoder to generate a first feature map, input the refined ground region information to a map encoder to generate a second feature map, and input the first feature map and the second feature map to the pedestrian situation estimation network to calculate the risk situation probability of the pedestrian.

The image encoder may be VGG19 trained on ImageNet in advance.

The map encoder may perform an atrous convolution operation.

In an embodiment of the present invention, the pedestrian situation estimation network includes a concatenation unit configured to concatenate the first feature map and the second feature map in a channel direction; a two-dimensional convolution unit configured to input the first feature map and the second feature map concatenated in the channel direction to a convolution layer to generate a fused feature; a flattening unit configured to flatten the fused feature; a first fully connected layer configured to input the flattened feature to a fully connected layer to generate a feature vector; an attention unit configured to input the feature vector to a multi-head self-attention layer to generate a pedestrian situation feature; and a second fully connected layer configured to input the pedestrian situation feature to a fully connected layer to calculate the risk situation probability of the pedestrian.

In an embodiment of the present invention, the processor 110 is configured to estimate the situation of the pedestrian as either a risk situation or a safe situation based on a risk situation probability of the pedestrian calculated by the pedestrian situation estimation network in a process of estimating the situation of the pedestrian.

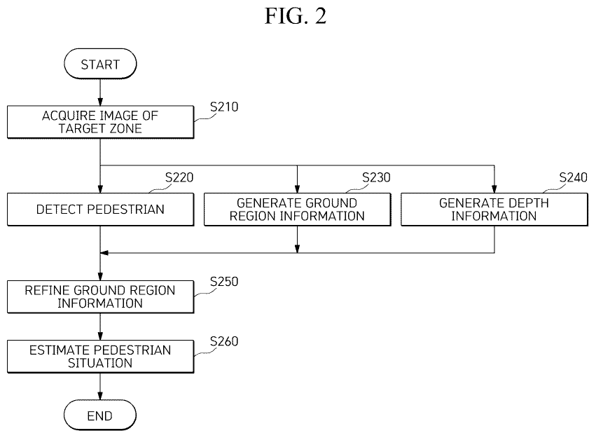

Hereinafter, an operation of the pedestrian situation estimation system 100 will be described in detail with reference to FIGS. 2 to 6.

FIG. 2 is a flowchart illustrating a pedestrian situation estimation method according to an embodiment of the present invention. The pedestrian situation estimation method illustrated in FIG. 2 may be performed by the pedestrian situation estimation system 100.

Referring to FIG. 2, the pedestrian situation estimation method according to the embodiment of the present invention includes operations S210 to S260. The pedestrian situation estimation method illustrated in FIG. 2 is an embodiment, and operations of the pedestrian situation estimation method according to the present invention are not limited to those illustrated in FIG. 2 and may be added, modified, or deleted as needed.

Operation S210 is an operation of acquiring an image of the target zone.

The camera 180 installed in the target zone acquires a video (for example, an RGB video, RGB frame, RGB-D video, or RGB-D frame) of the target zone and transmits the video to the pedestrian situation estimation system 100. “Target zone” in the present invention refers to a zone where pedestrians can pass. For example, the target zone may be a crosswalk or a school safety zone. The video may be a real-time stream video or may be a pre-stored video file.

Operation S220 is a pedestrian detection operation.

The processor 110 included in the pedestrian situation estimation system 100 detects a pedestrian appearing in the image of the target zone and generates area information of the pedestrian (hereinafter, “pedestrian area information”). The pedestrian area information may be a coordinate range of an area where the pedestrian is located or a bounding box surrounding the pedestrian (a pedestrian bounding box). The processor 110 may generate a bounding box within the video of people (pedestrians) (hereinafter, “pedestrian bounding box”) present in each RGB frame acquired by the camera 180. The present invention does not limit a method by which the processor 110 generates area information of the pedestrians (hereinafter, “pedestrian area information”) included in the image of the target zone.

Operation S230 is a ground region information generation operation.

Ground region information is information in which respective pixels included in the image of the target zone are classified into set classes (for example, a roadway, a curb, a sidewalk, and a non-ground region such as a building).

The ground region information may be a ground region map. In the ground region map, each class may be represented by a color. For example, the roadway may be represented as purple, the curb as gray, the sidewalk as pink, and the non-ground region as black. In the related art, the ground region information is often manually distinguished, whereas the present invention automatically generates the ground region information, such as a ground region map, from the image of the target zone.

The processor 110 automatically identifies areas (such as a roadway, crosswalk, or sidewalk) related to a road surface (road) in the image of the target zone using a semantic segmentation technique.

First, the processor 110 classifies an object to which each pixel belongs in the video (for example, an RGB frame) of the target zone to generate a segmentation map using the semantic segmentation technique. The semantic segmentation technique used in the present invention is not limited. The object may be classified as a non-road object such as a pedestrian or an automobile or a road object such as a road, a crosswalk, or a sidewalk.

The segmentation map generated by the processor 110 may be represented as a probability map for each of a plurality of preset classes. These classes may include the non-road object class such as a pedestrian and an automobile and the road object class such as a road, a crosswalk, and a sidewalk. That is, a target object of the segmentation map includes an area related to a road surface, such as a road, a crosswalk, and a sidewalk.

The processor 110 uses the segmentation map generated in this manner to automatically identify the area related to the road surface in the image of the target zone. Typically, various moving objects such as people and automobiles occlude the ground region in a single frame, making it difficult to accurately recognize a ground region for determining a semantic location of the pedestrian. To address this, a characteristic that change in the ground region over time is very small when the camera 180 is a fixed surveillance camera may be utilized. In other words, the processor 110 may generate ground region information by excluding information on a non-road object area from the segmentation map and extracting a road object area, based on accumulated image segmentation results (a segmentation map). For example, the processor 110 may generate ground region information (for example, a ground region map) by excluding object areas from the image segmentation results (segmentation map) and accumulating only a background area.

Operation S240 is a depth information generation operation.

The processor 110 estimates a relative distance between an object appearing in the image of the target zone and the camera 180 installed in the target zone based on the image of the target zone, to generate depth information (for example, a depth map or disparity map). To this end, the processor 110 may use a method of estimating a depth or disparity from an RGB image acquired from a single camera, or a method of measuring a depth based on an RGB-D image acquired from an RGB-D camera.

Operation S250 is an operation of refining the ground region information.

In this operation, the processor 110 refines the ground region information using the pedestrian area information, the segmentation map, and the depth information. Specifically, the processor 110 extracts ground region information (refined ground region information) actually adjacent to each pedestrian from the ground region information.

Information on the ground region surrounding the pedestrian is useful in determining whether the pedestrian is in a risk situation. However, with only two-dimensional information, it is difficult to ascertain whether the area actually corresponds to the area around the pedestrian or an area far from the pedestrian. When information on the area far from the pedestrian may be used to estimate the risk situation, estimation performance is likely to deteriorate. This problem becomes more severe when other objects such as traffic lights are present between the camera and the pedestrian. To address this problem, the present invention uses the depth information to filter (refine) the ground region information so that the area far from the pedestrian is excluded.

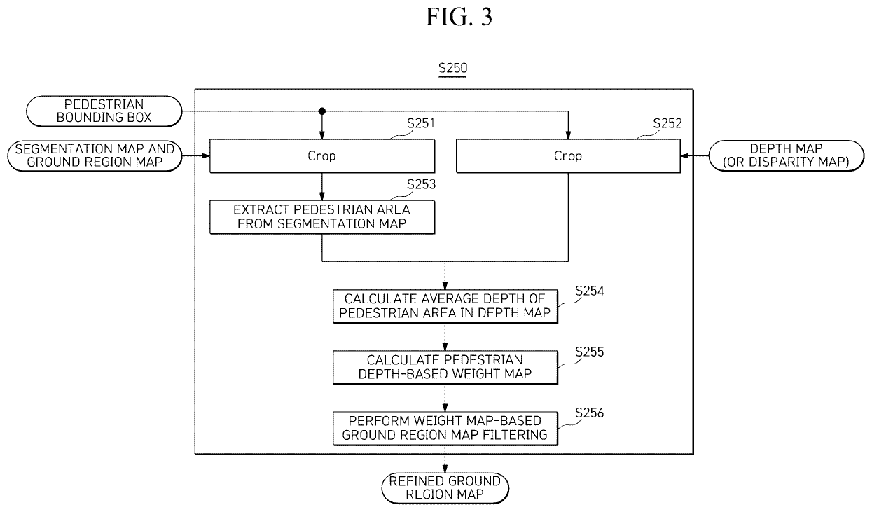

Hereinafter, an operation of the pedestrian situation estimation system 100 in operation S250 will be described in detail with reference to FIG. 3.

FIG. 3 is a diagram illustrating a process of refining the ground region map using depth information. For convenience of description, a case in which the pedestrian area information is a pedestrian bounding box, the ground region information is a ground region map, and the depth information is a depth map will be described.

First, the processor 110 crops a map having a size corresponding to k times (for example, 2 times) the bounding box of the pedestrian with reference to a center position of the bounding box from the segmentation map, the ground region map, and the depth map (S251 and S252). That is, the processor 110 generates a segmentation map, a ground region map, and a depth map cropped with reference to the bounding box of the pedestrian from the segmentation map, the ground region map, and the depth map.

Operations S251 and S252 are intended to extract a ground region actually adjacent to the pedestrian for each pedestrian and match a size of each cropped map with the image input to the pedestrian situation estimation network based on an artificial neural network.

Further, as shown in Formula 1, the processor 110 generates a mask for the pedestrian area (hereinafter referred to as a “pedestrian area mask”) using the segmentation map.

$$M ( x ) = \{ \begin{matrix}1 , & S ( x ) ∈ {C}_{person} , \\ 0 , & otherwise ,\end{matrix} \qquad [ Formula 1 ]$$

In Formula 1, x represents a pixel coordinate, S represents a segmentation map, and Cₚₑᵣₛₒₙ represents a class of the pedestrian.

The processor 110 applies the pedestrian area mask acquired in operation S253 to the cropped depth map to calculate the average depth Dₚₑᵣₛₒₙ of the pedestrian as shown in Formula 2 (S254).

$${D}_{person} = \frac{\sum D ( x ) ∘ M ( x )}{\sum M ( x )} , \qquad [ Formula 2 ]$$

In Formula 2, D represents the cropped depth map, and ∘ represents an element-wise multiplication operation (also known as a Hadamard product).

The processor 110 generates a weight map (W) with greater values closer to the average pedestrian depth calculated as described above using Formulas 3 and 4 (S255). In the present specification, the weight map (W) may be referred to as a “pedestrian depth-based weight map.”

$${D}^{′} ( x ) = \vert D ( x ) - {D}_{person} \vert , \qquad [ Formula 3 ]$$

$$W ( x ) = 1 - \frac{{D}^{′} ( x )}{max ( {D}^{′} ( x ) )} . \qquad [ Formula 4 ]$$

The processor 110 extracts a portion (a refined ground region map) that is an area of the ground region map whose depth is similar to that of the pedestrian by using the pedestrian depth-based weight map (W) (S256).

For example, the processor 110 may generate the refined ground region map G′ by extracting a portion of the pedestrian depth-based weight map (W) that is above an average value from the cropped ground region map G, as shown in Formula 5.

$${G}^{′} ( x ) = \{ \begin{matrix}G ( x ) , & W ( x ) \geq mean ( W ( x ) ) , \\ 0 , & otherwise ,\end{matrix} \qquad [ Formula 5 ]$$

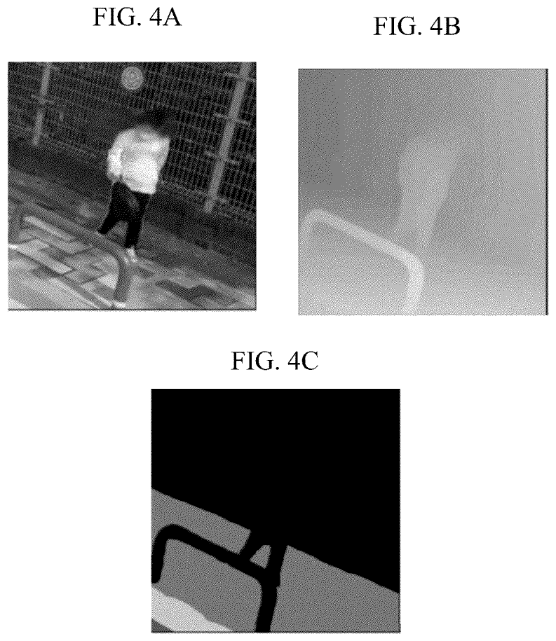

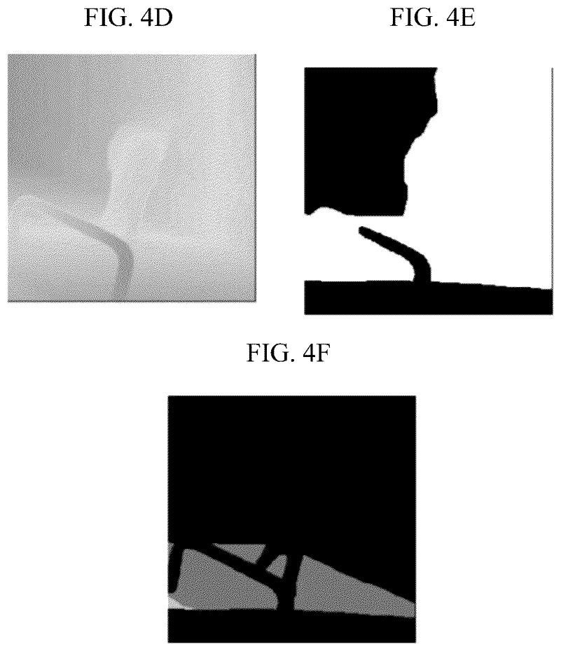

In Formula 5, G represents the cropped ground region map, and G′ represents the refined ground region map. In other words, Formula 5 may be a formula related to a “weight map-based filter” (see FIG. 4E) that extracts pixels above the average value of the pedestrian depth-based weight map (W) from the cropped ground region map G.

However, the present invention is not limited to the above-described method, and any method of removing an area in which a difference in depth from the pedestrian exceeds a threshold and emphasizing an area whose depth is similar to that of the pedestrian may be used.

FIGS. 4A to 4F are illustrative diagrams of data related to a process of refining the ground region map using the depth map.

FIG. 4A illustrates an example of the image of the area around the pedestrian extracted from the image of the target zone, which is a portion twice the size of the pedestrian bounding box. FIG. 4B illustrates an example of a depth map (more precisely, a cropped disparity map) cropped from the area illustrated in FIG. 4A, and FIG. 4C illustrates an example of a ground region map cropped from the area illustrated in FIG. 4A.

For reference, disparity in the disparity map represents a horizontal position difference between objects that appear identically in left and right images in stereo vision, and the disparity tends to increase when the objects are closer to each other. In other words, the disparity is inversely proportional to a depth, and the disparity map and the depth map have a reciprocal relationship. Therefore, the disparity map and the depth map may be converted into each other, and the disparity map may be used instead of the depth map as the depth information.

FIG. 4D illustrates an example of the pedestrian depth-based weight map for a relevant area. In FIG. 4D, an area similar to the depth of the pedestrian (a portion with a small difference from the average depth of the pedestrian) is a portion with a high weight and is represented in yellow, and an area farther from the pedestrian (a portion with a lower weight) is represented in darker turquoise.

Further, FIG. 4E illustrates an example of the weight map-based filter, and FIG. 4F illustrates an example of the refined ground region map. In the weight map-based filter illustrated in FIG. 4E, the pixels with values above the average value of the pedestrian depth-based weight map (W) are represented in white, and pixels with values below the weight map (W) are represented in black. In FIGS. 4C and 4F, a curb is represented in gray, a roadway at a lower left is represented in purple, a sidewalk is represented in pink, and a non-ground region is represented in black.

Referring back to FIG. 2, operation S260 will be described.

Operation S260 is an operation of estimating the situation of the pedestrian.

The processor 110 estimates the situation of the pedestrian using the pedestrian situation estimation network based on an artificial neural network, based on pedestrian area information (for example, a pedestrian bounding box), the image of the target zone, and the refined ground region information.

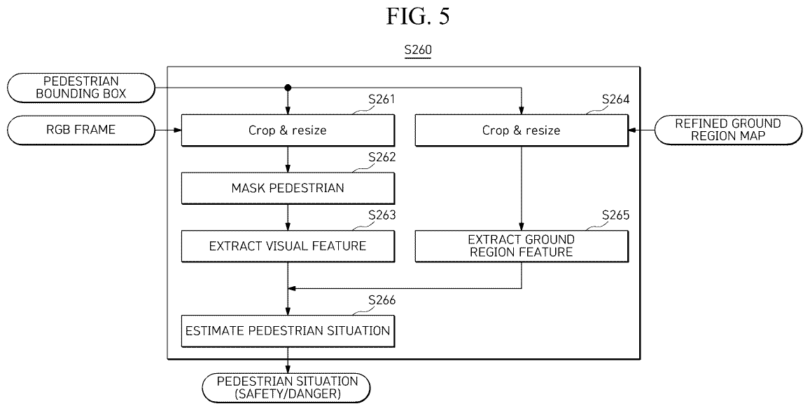

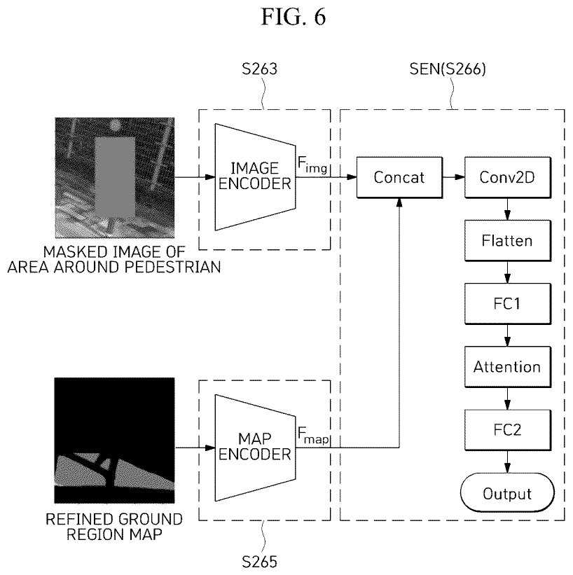

Hereinafter, an operation of the pedestrian situation estimation system 100 in operation S260 will be described in detail with reference to FIGS. 5 and 6.

FIG. 5 is a diagram illustrating a process of estimating a situation of the pedestrian, and FIG. 6 is a diagram illustrating a structure of an artificial neural network (pedestrian situation estimation network) that estimates the situation of the pedestrian.

For convenience of description, a case in which the pedestrian area information is the pedestrian bounding box and the ground region information is the ground region map will be described.

The processor 110 estimates whether the pedestrian is at a potentially risk location (for example, a roadway or crosswalk) or in a safe area (for example, a sidewalk) by using an image of an area surrounding the pedestrian extracted from the image of the target zone (for example, an RGB frame) with reference to the pedestrian bounding box (for example, an image twice the size with respect to a center position of the pedestrian bounding box may be extracted) and the refined ground region map acquired in operation S250. To effectively fuse the RGB frame with the information of the refined ground region map, the processor 110 may use the pedestrian situation estimation network (SEN) based on an artificial neural network illustrated in FIG. 6.

First, the processor 110 crops an area corresponding to k times (for example, twice) the bounding box of each pedestrian and resizes the area to a predetermined size (for example, 224×224) to generate an image of the area around the pedestrian in order to extract visual features of the area around the pedestrian from the image (for example, an RGB frame) of the target zone (S261).

The processor 110 masks (for example, fills in gray) an area occupied by the pedestrian bounding box in the image of the area around the pedestrian to prevent the extraction of visual information of the pedestrian (S262; see FIG. 6). The image generated in operation S262 may be referred to as a masked image of the area around the pedestrian. As another example, the processor 110 may also generate a masked image of the area around the pedestrian by masking the area occupied by the pedestrian in the image of the area around the pedestrian on the segmentation map.

The processor 110 inputs the masked image of the area around the pedestrian to the pre-trained image encoder to generate a first feature map F_{img} (S263; see FIG. 6). For example, the image encoder may be VGG19 trained on ImageNet in advance. In this case, the processor 110 inputs the image of the area around the pedestrian in which the bounding box of the pedestrian area is occluded (the masked image of the area around the pedestrian) to VGG19, and acquires the first feature map F_{img} from an output of a last convolution layer of VGG19. The first feature map includes visual features of the image of the area around the pedestrian.

Meanwhile, the refined ground region map includes ground information at a depth adjacent to the pedestrian for ascertaining the ground on which the pedestrian is standing. To extract this information, the processor 110 converts the refined ground region map into an RGB image. The processor 110 crops the same area as the image of the area around the pedestrian from the RGB image of the refined ground region map and resizes the area to a predetermined size (for example, 224×224) (S264).

The processor 110 inputs the cropped and resized ground region map (indicated as “refined ground region map” in FIG. 6) to the map encoder to generate a second feature map Fₘₐₚ (S265). In this process, the atrous convolution may be used to extract wider spatial features without down sampling. For example, the processor 110 applies three 3×3 atrous convolutions in which the numbers of filters are 32, 64, and 128 and dilation rates are 2, 4, and 8 to the refined ground region map, and applies 32×32 max pooling to an output of a last layer to extract the second feature map Fₘₐₚ. The second feature map includes ground information features of the pedestrian and the area around the pedestrian.

The processor 110 inputs the first feature map and the second feature map to the pedestrian SEN to estimate the situation (safety/danger) of the pedestrian (S266).

As illustrated in FIG. 6, the pedestrian SEN may include a concatenation unit Concat, a two-dimensional convolution unit Conv2D, a flattening unit Flatten, a first fully connected layer, an attention unit Attention, and a second fully connected layer.

Hereinafter, an example of a structure of the pedestrian SEN in connection with operation S266 will be described with reference to FIG. 6.

The concatenation unit Concat receives the first feature map F_{img} and the second feature map Fₘₐₚ and concatenates the maps in a channel direction. In the present example, to fuse features while maintaining two-dimensional spatial information present in the feature map, the concatenation unit Concat concatenates the first feature map and the second feature map in the channel direction, and a convolution layer with a kernel size of 3×3 and 512 filters is applied to the two-dimensional convolution unit Conv2D connected to the concatenation unit Concat. Since an output of the concatenation unit Concat includes two 3D matrices simply arranged in the channel direction, a visual feature and a ground information feature exist separately. The two-dimensional convolution unit Conv2D serves to combine and extract fused features for subsequent pedestrian situation estimation (classification).

Further, to convert the features fused by the two-dimensional convolution unit Conv2D into a one-dimensional feature vector, a flattening layer is applied to the flattening unit Flatten, and a fully connected layer with 512 units is applied to a first fully connected layer FC1.

The attention unit Attention is introduced to focus on learning a part of a feature vector generated by the first fully connected layer FC1 that is helpful for classification. The attention unit Attention includes eight heads, each of which includes a 32-dimensional multi-head self-attention layer. The attention unit Attention receives the feature vector generated by the first fully connected layer FC1, generates the pedestrian situation features, and passes the pedestrian situation features to the second fully connected layer FC2.

Finally, a fully connected layer with a single unit is applied to the second fully connected layer FC2, which is configured to receive the pedestrian situation features and to finally output the risk situation probability of the pedestrian. The processor 110 may estimate the situation of the pedestrian as a risk situation when the risk situation probability generated by the second fully connected layer FC2 exceeds a predetermined threshold, and otherwise estimate the situation of the pedestrian as a safe situation.

The pedestrian situation estimation method has been described above with reference to the flowchart presented in the drawings. For simplicity of description, the method has been illustrated and described as a series of blocks, but the present invention is not limited to the order of the blocks, and some blocks may occur in a different order from that illustrated and described herein or simultaneously with other blocks, and various other branches, flow paths, and block orders that achieve the same or similar results may be implemented. Further, not all illustrated blocks may be required to implement the method described herein.

Meanwhile, in the descriptions with reference to FIGS. 2 to 6, respective operations may be further divided into additional operations or combined into fewer operations according to the implementation of the present invention. Further, some operations may be omitted as needed, and an order of operations may be changed. Further, even when other content is omitted, the content of FIG. 1 may be applied to the content of FIGS. 2 to 6. Further, the content of FIGS. 2 to 6 may be applied to the content of FIG. 1.

Hereinafter, performance evaluation results of the pedestrian situation estimation method according to the present invention will be described.

To evaluate the quantitative performance of the present invention, 200 video clips (each 30 seconds long) included in “Image of Children Pedestrian Risk Behaviors in School Safety Zone” provided in AI hub (https://aihub.or.kr) were used. 71,898 risk situation ROIs and 68,181 safety situation ROIs were generated from the videos, and the video clips were divided into a training set and a testing set, each of which included 100 video clips for evaluation. Accuracy (ACC), precision, recall, F1 score, and an area under an ROC curve (AUC) were used as evaluation indices. The accuracy, the precision, and the recall are defined as in Formulas 6, 7, and 8, respectively.

$$ACC = \frac{TP + TN}{TP + TN + FP + FN} , \qquad [ Formula 6 ]$$

$$Precision = \frac{TP}{TP + FP} \qquad [ Formula 7 ]$$

$$Recall = \frac{TP}{TP + FN} , \qquad [ Formula 8 ]$$

In Formulas 6 to 8, TP represents the number of true positive samples, TN represents the number of true negative samples, FP represents the number of false positive samples, and FN represents the number of false negative samples. In other words, a false positive (FP) indicates a case in which the sample is actually negative, but is determined to be positive by a binary classification model, true positive (TP) indicates a case in which the sample is actually positive (for example, a risk situation), and is also determined to be positive by the binary classification model, true negative (TN) indicates a case in which the sample is actually negative, and is also determined to be negative by the binary classification model, and false negative (FN) indicates a case in which the sample is actually positive, but is determined to be negative by the binary classification model.

The F1 score is a harmonic mean of the precision and the recall, and provides a balanced assessment value for model performance. Formula 9 is a formula for calculating the F1 score.

$$F 1 = \frac{2 \times precision \times recall}{prec i s i o n + r e c a l l} . \qquad [ Formula 9 ]$$

The AUC represents an area under the ROC curve and is defined as shown in Formula 10.

$$AUC ( p ) = \frac{{\sum }_{{s}_{0} ∈ {S}^{0}} {\sum }_{{s}_{1} ∈ {S}^{1}} 1 [ p ( {s}_{0} ) < p ( {s}_{1} ) ]}{\vert {S}^{0} \vert \cdot \vert {S}^{1} \vert} , \qquad [ Formula 10 ]$$

In Formula 10, p represents a probability of a safe situation for a relevant sample, 1[f(∘)] is a function that is 1 when an inner function is true and 0 when an inner function is false, S⁰ is the set of negative samples, and S¹ is the set of positive samples.

Table 1 below shows experimental results for a pedestrian situation estimation. As shown in Table 1, it can be seen that considering both the RGB image and the ground region information is more useful than simply using only the RGB image in improving risk situation estimation performance. Further, it can be seen that superior estimation performance is achieved by utilizing only ground region information with the depth actually similar to that of the pedestrian (“present invention” in Table 1) in the proposed method, rather than by simply utilizing all the ground region information.

TABLE 1

| | Accuracy | | | | |
|---|---|---|---|---|---|
| Input data | (ACC) | AUC | F1 | Precision | Recall |
| RGB image | 0.739 | 0.802 | 0.659 | 0.606 | 0.724 |
| RGB image + | 0.888 | 0.908 | 0.839 | 0.840 | 0.838 |
| ground | | | | | |
| region map | | | | | |
| Present | 0.919 | 0.926 | 0.876 | 0.937 | 0.823 |
| invention | | | | | |

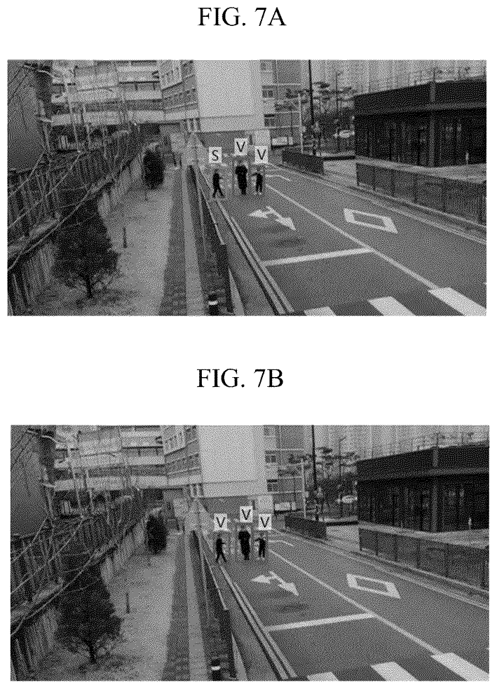

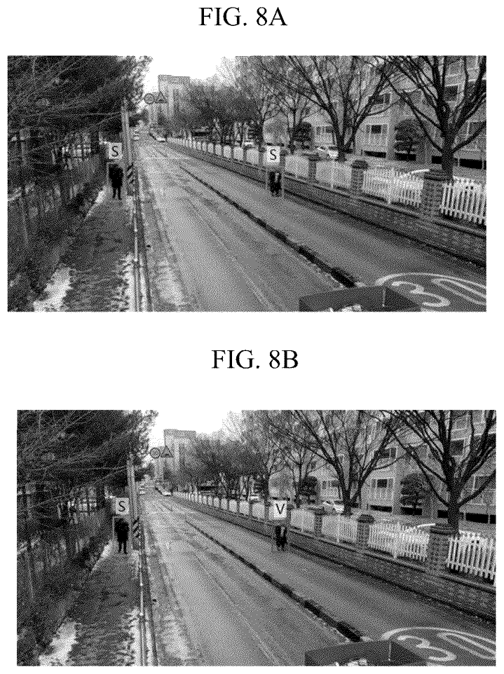

FIGS. 7A to 8B are diagrams illustrating a comparison of pedestrian situation estimation results of the related art and the present invention. Specifically, FIGS. 7A to 8B are diagrams illustrating results of determining a potentially risk situation of each pedestrian and estimating the pedestrian situation using a bounding box in an image clip of the testing set described above. In FIGS. 7A to 8B, a green bounding box S indicates a safe situation, and a red bounding box V indicates a risk situation (or pedestrian vulnerability).

FIGS. 7A and 8A show pedestrian situation estimation results according to the related art, which are results of estimating the situation of the pedestrian using the RGB image and the ground region map without utilizing the depth information. FIGS. 7B and 8B show pedestrian situation estimation results according to the present invention, which are results of estimating the situation of the pedestrian by additionally using the depth information.

It can be confirmed from FIGS. 7A and 8A that, when a conventional method is used, some pedestrians on a road are incorrectly estimated to be safe, but when the method proposed in the present invention is used (FIGS. 7B and 8B), a situation of pedestrians on a road is accurately classified as a risk situation (V). Therefore, it is possible to construct a pedestrian protection system capable of warning a driver or a pedestrian when the situation of the pedestrian is determined to be a risk situation, based on the pedestrian situation estimation system or method proposed in the present specification.

The related art has the limitation that a surveillance camera has to be installed toward a region of interest such as a crosswalk to determine a walking situation of a pedestrian. Compared to the related art, the present invention is relatively free from the limitation on surveillance camera installation locations.

Further, unlike the related art in which the region of interest is mostly designated manually by a user, the present invention has the advantage of automatically finding the region of interest, thereby providing ease of use and enabling response even to a subtle change in a shooting direction of the surveillance camera over time.

Further, the present invention has the advantage of estimating a risk situation of a pedestrian using depth information extracted from an RGB image even when a depth camera is not included, and improving the accuracy of risk situation estimation compared to the related art.

The effects of the present invention are not limited to those described above, and other effects that are not mentioned will be clearly understood by those skilled in the art from the above description.

While the present invention has been described above with reference to preferred embodiments, it will be understood by those skilled in the art that various modifications and variations may be made to the present invention without departing from the spirit and scope of the present invention as set forth in the claims below.

What is claimed is:

1. A pedestrian situation estimation system comprising:
a memory configured to store computer-readable instructions; and
at least one processor implemented to execute the instructions,
wherein the at least one processor is configured to execute the instructions to:
generate pedestrian area information, which is information on an area occupied by a pedestrian appearing in an image of a target zone, based on the image of the target zone;
apply a semantic segmentation technique to the image of the target zone to generate a segmentation map and extract ground region information, which is information in which a ground region is distinguished, from the segmentation map;
generate depth information of an object area appearing in the image of the target zone based on the image of the target zone; and
estimate a situation of the pedestrian using a pedestrian situation estimation network based on an artificial neural network, based on the image of the target zone, the pedestrian area information, the segmentation map, the ground region information, and the depth information.

2. The pedestrian situation estimation system of claim 1, wherein the at least one processor is configured to, in a process of generating the depth information, generate the depth information by estimating a relative distance between each of pixels representing a plurality of objects appearing in the image of the target zone and a camera installed in the target zone, based on the image of the target zone.

3. The pedestrian situation estimation system of claim 1, wherein the depth information is either a depth map or a disparity map.

4. The pedestrian situation estimation system of claim 1, wherein the at least one processor is configured to, in a process of estimating the situation of the pedestrian,
calculate an average depth of the pedestrian based on the segmentation map, the pedestrian area information, and the depth information, and extract a ground region having a depth difference within a predetermined threshold from the average depth of the pedestrian from the ground region information to generate refined ground region information; and
extract an image of an area around the pedestrian from the image of the target zone using the pedestrian area information, encode the image of the area around the pedestrian and the refined ground region information, and input these to the pedestrian situation estimation network to calculate a risk situation probability of the pedestrian.

5. The pedestrian situation estimation system of claim 4, wherein the at least one processor is configured to, in a process of generating the refined ground region information,
crop an area corresponding to a predetermined multiple of an area occupied by the pedestrian from the ground region information and the depth information based on the pedestrian area information;
generate a pedestrian area mask, which is a mask for the area occupied by the pedestrian, using the segmentation map and apply the pedestrian area mask to the cropped depth information to calculate the average depth of the pedestrian; and
extract a ground region having a depth difference within a predetermined threshold from the average depth of the pedestrian from the cropped ground region information to generate the refined ground region information.

6. The pedestrian situation estimation system of claim 4, wherein the at least one processor is configured to, in a process of calculating a risk situation probability of the pedestrian,
crop an area corresponding to a predetermined multiple of an area occupied by the pedestrian from the image of the target zone based on the pedestrian area information to generate the image of the area around the pedestrian;
mask the area occupied by the pedestrian in the image of the area around the pedestrian;
input the masked image of the area around the pedestrian to a pre-trained image encoder to generate a first feature map;
input the refined ground region information to a map encoder to generate a second feature map; and
input the first feature map and the second feature map to the pedestrian situation estimation network to calculate the risk situation probability of the pedestrian.

7. The pedestrian situation estimation system of claim 6, wherein the image encoder is VGG19 trained on ImageNet in advance.

8. The pedestrian situation estimation system of claim 6, wherein the map encoder performs an atrous convolution operation.

9. The pedestrian situation estimation network of claim 6, wherein the pedestrian situation estimation network includes:
a concatenation unit configured to concatenate the first feature map and the second feature map in a channel direction;
a two-dimensional convolution unit configured to input the first feature map and the second feature map concatenated in the channel direction to a convolution layer to generate a fused feature;
a flattening unit configured to flatten the fused feature;
a first fully connected layer configured to input the flattened feature to a fully connected layer to generate a feature vector;
an attention unit configured to input the feature vector to a multi-head self-attention layer to generate a pedestrian situation feature; and
a second fully connected layer configured to input the pedestrian situation feature to a fully connected layer to calculate the risk situation probability of the pedestrian.

10. The pedestrian situation estimation system of claim 1, wherein the at least one processor is configured to, in a process of estimating the situation of the pedestrian, estimate the situation of the pedestrian as either a risk situation or a safe situation based on a risk situation probability of the pedestrian calculated by the pedestrian situation estimation network.

11. A pedestrian situation estimation method, comprising:
generating, by a pedestrian situation estimation system, pedestrian area information, which is information on an area occupied by a pedestrian appearing in an image of a target zone, based on the image of the target zone;
applying, by the pedestrian situation estimation system, a semantic segmentation technique to the image of the target zone to generate a segmentation map and extracting ground region information, which is information in which a ground region is distinguished, from the segmentation map;
generating, by the pedestrian situation estimation system, depth information of an object area appearing in the image of the target zone based on the image of the target zone; and
estimating, by the pedestrian situation estimation system, a situation of the pedestrian using a pedestrian situation estimation network based on an artificial neural network, based on the image of the target zone, the pedestrian area information, the segmentation map, the ground region information, and the depth information.

12. The pedestrian situation estimation method of claim 11, wherein the generating of the depth information includes generating, by the pedestrian situation estimation system, the depth information by estimating a relative distance between each of pixels representing a plurality of objects appearing in the image of the target zone and a camera installed in the target zone, based on the image of the target zone.

13. The pedestrian situation estimation method of claim 11, wherein the depth information is either a depth map or a disparity map.

14. The pedestrian situation estimation method of claim 11, wherein the estimating of the pedestrian situation includes:
calculating, by the pedestrian situation estimation system, an average depth of the pedestrian based on the segmentation map, the pedestrian area information, and the depth information, and extracting a ground region having a depth difference within a predetermined threshold from the average depth of the pedestrian from the ground region information to generate refined ground region information; and
extracting, by the pedestrian situation estimation system, an image of an area around the pedestrian from the image of the target zone using the pedestrian area information, encoding the image of the area around the pedestrian and the refined ground region information, and inputting these to the pedestrian situation estimation network to calculate a risk situation probability of the pedestrian.

15. The pedestrian situation estimation method of claim 14, wherein the generating of the refined ground region information includes:
cropping an area corresponding to a predetermined multiple of the area occupied by the pedestrian from the ground region information and the depth information based on the pedestrian area information;
generating a pedestrian area mask, which is a mask for the area occupied by the pedestrian, using the segmentation map, and applying the pedestrian area mask to the cropped depth information to calculate the average depth of the pedestrian; and
extracting a ground region having a depth difference within a predetermined threshold from the average depth of the pedestrian from the cropped ground region information to generate the refined ground region information.

16. The pedestrian situation estimation method of claim 14, wherein the calculating of the risk situation probability of the pedestrian includes:
cropping an area corresponding to a predetermined multiple of an area occupied by the pedestrian from the image of the target zone based on the pedestrian area information to generate the image of the area around the pedestrian;
masking the area occupied by the pedestrian in the image of the area around the pedestrian;
inputting the masked image of the area around the pedestrian to a pre-trained image encoder to generate a first feature map;
inputting the refined ground region information to a map encoder to generate a second feature map; and
inputting the first feature map and the second feature map to the pedestrian situation estimation network to calculate the risk situation probability of the pedestrian.

17. The pedestrian situation estimation method of claim 16, wherein the image encoder is VGG19 trained on ImageNet in advance.

18. The pedestrian situation estimation method of claim 16, wherein the map encoder performs an atrous convolution operation.

19. The pedestrian situation estimation method of claim 16, wherein the pedestrian situation estimation network includes:
a concatenation unit configured to concatenate the first feature map and the second feature map in a channel direction;
a two-dimensional convolution unit configured to input the first feature map and the second feature map concatenated in the channel direction to a convolution layer to generate a fused feature;
a flattening unit configured to flatten the fused feature;
a first fully connected layer configured to input the flattened feature to a fully connected layer to generate a feature vector;
an attention unit configured to input the feature vector to a multi-head self-attention layer to generate a pedestrian situation feature; and
a second fully connected layer configured to input the pedestrian situation feature to a fully connected layer to calculate the risk situation probability of the pedestrian.

20. The pedestrian situation estimation method of claim 11, wherein the estimating of the situation of the pedestrian includes estimating the situation of the pedestrian as either a risk situation or a safe situation based on the risk situation probability of the pedestrian calculated by the pedestrian situation estimation network.
